(19) United States
(12) Patent Application Publication
(10) Pub. No.: US 2005/0157772 A1
(43) Pub. Date: Jul. 21, 2005

(54) Temperature detecting method

(75) Inventors: Roland Fischer, Nidderau (DE); Andre Strobel, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, STUTTGART (DE)

(21) Appl. No.: 11/017,739

(22) Filed: Dec. 22, 2004

(30) Foreign Application Priority Data
Dec. 23, 2003 (DE) 103 60 676.9

(51) Int. Cl. G01J 5/00

(52) U.S. Cl. 374/131

(57) ABSTRACT

A method and apparatus for detecting temperature use a first temperature detecting device to detect temperature is a first region, a calibrating device and a second temperature detecting device to detect a second temperature value in a second region contained in the first region. The calibrating device calibrates the first temperature detecting device by means of the second temperature value.

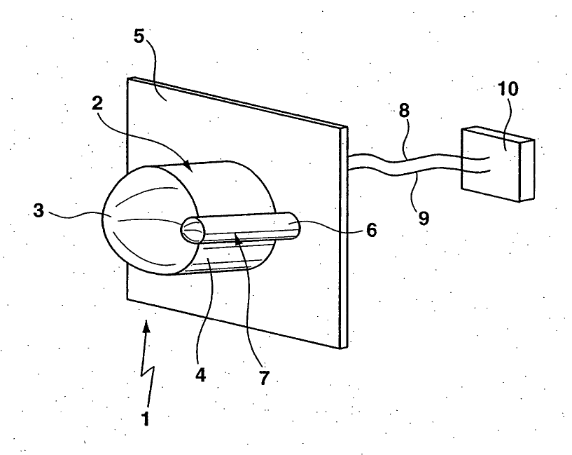

### BACKGROUND AND SUMMARY OF THE INVENTION

This application claims the priority of German patent document DE 103 60 676.9, filed Dec. 23, 2003, the disclosure of which is expressly incorporated by reference herein.

The invention relates to a method and apparatus for detecting a temperature using a first temperature detecting device detecting a first region.

An automobile driver's or occupant's face temperature represents a good measurement of his or her comfort. In addition, the temperature of the body surface can be used to measure comfort. When the face or body temperature can be measured, it is possible, using face temperature as a controlled variable, to build up a highly efficient air conditioning control, because the occupants' well-being is used directly as the controlled variable for the air conditioning control. For this purpose, the face temperature should be measured with a high accuracy, the required minimum accuracy being a deviation of not more than 0.25° C. Such accuracy, however, is not available at a cost acceptable for a series production. When measuring the body temperature as a controlled variable, a slightly less accurate measurement of the temperature of the body surface is sufficient, but no solution is available that would be sufficiently favorable with respect to a series production.

Infrared cameras are known which are capable of measuring the temperature of surfaces with a very high accuracy. However, such cameras are very expensive. While less highly resolving infrared sensor arrays are available at relatively low cost, because of the necessary lens system, they measure too inaccurately or tend to result in a crosstalk of the individual pixels under vehicle conditions.

Furthermore, infrared cameras are known which are used for the purpose of detecting the occupant's head position. On the basis of the temperatures differences with respect to the environment, such cameras can detect the head position at relatively low expenditures. Infrared cameras of this type are reasonably priced. However, low temperature accuracy is sufficient for detecting the head position because only temperature differences are to be measured.

A cost-effective arrangement for detecting the temperature of the face or the temperature of the body surface of a vehicle occupant is not known from the prior art.

It is therefore an object of the present invention to provide a temperature detection method and apparatus which can accurately determine the face and/or body temperature of an occupant of a motor vehicle.

This and other objects and advantages are achieved by the method and apparatus according to the invention, in which a first temperature value is detected based on one or more temperature(s) measured in a first region by a first temperature detecting device, and a second, more accurate temperature value is determined in a second region contained in the first region. The first temperature detecting device is then calibrated by means of the second temperature value, particularly by comparing the temperature values. The first and/or the second temperature value may be average temperatures if a temperature is detected in the respective regions at different points, or may be a measured temperature. By means of such a method, a sufficiently precise determination of a temperature of a sufficiently large region of an occupant can be carried out for a temperature or air-conditioning control in a motor vehicle.

In a variant of the method, the first temperature value is determined by forming an average value for a cutout of the first region essentially corresponding to the second region, from temperatures measured at several points within the cutout. When determining the average value, the individual temperatures can be weighted differently, for example, as a function of their position in the cutout. Particularly if the first temperature detecting device is constructed as a thermal imaging cameras the sensor elements or pixels are determined which cover the second region and the (weighted) average value is determined for the temperatures detected by the sensor elements. This average value is compared with the second temperature value determined in the second region by the second temperature detecting device (for example, an infrared sensor or temperature sensor), the second temperature detecting device detecting the temperature with a higher precision than the first temperature detecting device. In the event of a deviation of the temperature values, the temperatures measured by the sensor elements of the first temperature detecting device are shifted corresponding to the deviation.

In a preferred variant of the method, it may be provided that the first and second temperature are determined in a vehicle occupant's surface region. In particular, the face temperature of a vehicle occupant can be determined. The occupant's face temperature detected over a large surface by means of the calibrated first temperature detecting device can be used for a particularly precise air-conditioning control.

In a further preferred variant of the method, it can be provided that a third temperature value is detected in a third region contained in the first region. By means of this third detected temperature, temperature differences of the sensor elements of the first temperature detecting device can be resolved. Inaccuracies during the temperature measuring by the first temperature detecting device can thereby be determined and compensated.

In a variant of the method, parameters and/or correcting variables of a temperature control arrangement are determined corresponding to a temperature value detected by the calibrated first temperature detecting device. In this case, the temperature value may be a quantity describing an occupant's face temperature, which quantity was determined from several temperatures measured in the occupant's facial field. As a result of this measure, the comfort of vehicle occupants can be increased.

The object is also achieved by means of a temperature determination arrangement having a first temperature detecting device detecting a first region, for determining a first temperature value, with a calibrating device and a seconding temperature detecting device being provided for determination of a second temperature value in a second region contained in the first region. The calibrating device calibrates the first temperature detecting device by means of the second temperature value.

By means of relatively less accurate, reasonably priced first temperature detecting devices, a first temperature value describing the temperature of a larger region, such as an occupant's face or body surface, can be determined. By means of the second temperature detecting device, a second temperature value is measured or determined more accurately or with a greater resolution in a second, spatially narrowly limited region. On the basis of the second temperature value, the first temperature detecting device is calibrated by the calibrating device. In this manner, a vehicle occupant's face and/or body temperature can be determined using a relatively inaccurate, first temperature detecting device, with a deviation of maximally 0.25° C. The body or face temperature determined in this manner can be fed as a controlled variable directly to a temperature control arrangement, such as a vehicle air conditioner. Particularly in the case of a vehicle, the use of a larger number of air-conditioning-relevant sensors to determine the air temperature or the nozzle outlet temperature, will not be necessary.

In a particularly preferred embodiment, it is provided that the first temperature detecting device is constructed as a thermal imaging camera (particularly an infrared camera). Since only a low accuracy is required, the infrared camera may have a cost-effective construction. The thermal imaging camera can, for example, be directed to a vehicle occupant's head. By means of a suitable algorithm, it can be detected which pixels of the taken thermal image are part of the occupant's face. Thus, particularly during head movements, the relevant pixels can always be determined.

From the latter pixels, the first temperature value can be determined (for example, by a direct or weighted averaging), which describes the occupant's face temperature. This first temperature value is corrected by means of the second temperature value measured or determined in the occupant's face (for example, by calibrating the first temperature detecting device), and is used for the temperature control. In this case, the occupant's face may take up only a partial area of the taken thermal image. In the remaining lens coverage of the first temperature detecting device, additional temperature values (for example, of vehicle windows) can be detected or determined, which can also be entered into the air-conditioning control. The offset determined by the comparison of the first and second temperature values can also be applied to the additional temperature values, so that an accurate (surface) temperature can be determined also in additional vehicle areas.

In a preferred embodiment, it is provided that the thermal imaging camera comprises an array of microstructured bolometers, thermoelements or pyroelectric elements. Such thermal imaging cameras can be produced particularly cost-effectively.

In a further preferred embodiment, the second temperature detecting device is constructed as a sensor (particularly an infrared sensor of a high temperature accuracy). This means that a reasonably priced infrared camera can be combined with a high-precision individual infrared sensor which, as an individual sensor is, in turn, cost-effective. On the whole, a temperature determining arrangement is thereby created which can be implemented in a cost-effective manner and which permits a temperature control of the interior (of, for example, a vehicle) by means of the measured face or body temperature of persons situated in the interior. However, the sensor may also be a conventional temperature sensor which is arranged in the vehicle driver's or occupant's proximity. The sensor can, for example, be arranged in the seat, in the neckrest or in the seat belt, but always within the detection range of the first temperature detecting device.

In a further preferred embodiment of the invention, the second temperature detecting device, particularly the sensor, is arranged in or on a housing of the first temperature detecting device, particularly the thermal imaging camera. As a result of an arrangement inside the housing of the thermal imaging camera, a compact temperature detecting arrangement can be created. The sensor and the thermal imaging camera are preferably directed onto the same region.

In still another embodiment, it can be provided that the first and second temperature detecting devices each have their own housing and are adjusted with respect to one another. The adjustment ensures that both temperature detecting devices are directed onto the same region.

The housings of the temperature detecting devices can be connected with one another. This facilitates the adjustment to the same face region or body part.

In another alternative, it may be provided that the first and second temperature detecting devices are integrated on a chip. This results in a particularly space-saving and cost-effective arrangement of the high-resolution sensor.

In an advantageous embodiment, it can be provided that the calibrating device comprises an electronic circuit to which the signals of the first and second temperature detecting devices are fed, particularly separately. An electronic circuit of this type permits rapid calibration of the temperature of the first temperature detecting device. In an alternative embodiment of the invention, the signals of the temperature detecting device can be fed to an air-conditioning control unit. The calibration can take place there, and the result of the calibrated temperature measurement by the first temperature detecting device can be fed directly to the air-conditioning control.

In an advantageous embodiment, a third temperature detecting device can be provided for detecting a third temperature in a third region contained in the first region. By comparing the first and the second temperature values, an offset of the temperature detected by the first temperature detecting device can be determined and the measured temperature can be corrected correspondingly. By comparing the first temperature value or the calibrated first temperature value with the third temperature value, inaccuracies of the temperature detection by the first temperature detecting device can be recognized and corrected.

An air conditioner with a temperature detecting arrangement is also within the scope of the invention.

Other objects, advantages and novel features of the present invention will become apparent from the following detailed description of the invention when considered in conjunction with the accompanying drawings.

### BRIEF DESCRIPTION OF THE DRAWINGS

The single FIGURE of the drawing is a schematic view of a temperature detecting arrangement according to the invention.

### DETAILED DESCRIPTION OF THE DRAWINGS

The FIGURE schematically illustrates a temperature detecting arrangement 1. A first temperature detecting device 2, which may be, for example, an infrared camera, comprises a chip, on which an array of several sensor elements is arranged, and a lens 3 and a housing 4. The first temperature sensor is arranged on a printed circuit board 5, with a second temperature detecting device 7, constructed as an infrared sensor, arranged in a separate housing 6, directly adjacent thereto. The first and the second temperature detecting devices 2, 7 are mutually adjusted and are directed onto a driver's face (not shown). The printed circuit board 5 has an analyzing circuit which is part of a calibrating device and, based on the second temperature measured by the second temperature detecting device 7, calibrates the first temperature detecting device or the first temperature determined by it.

The temperature detecting arrangement 1 is connected with an air-conditioning control unit 10 by way of lines 8, 9. The first temperature detecting device 2 detects the temperature of a vehicle occupant's face relatively less accurately in a large first region. The second temperature detecting device 7 detects the vehicle occupant's face temperature in a second, much smaller region which is situated in the first region. On the basis of the temperature measured much more accurately by the second temperature detecting device 7, the first temperature detecting device 2 can be calibrated, so that the temperature of a sufficiently large region of a vehicle occupant can be determined with sufficient precision for an air-conditioning control.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method of detecting a temperature, said method comprising:
determining a first temperature value in a first region based on at least one temperature measured by a first temperature detecting device; and
determining a second, relatively more accurate temperature value in a second region contained in the first region; and
calibrating the first temperature detecting device by means of the second temperature value.

2. The method according to claim 1, wherein said calibrating step comprises comparing the temperature values.

3. The method according to claim 1, wherein the first temperature value is determined by forming an average value from temperatures measured at several points within a cutout of the first region, essentially corresponding to the second region.

4. The method according to claim 3, wherein the first and second temperature values are determined in a surface region of a vehicle occupant.

5. The method according to claim 4, wherein a vehicle occupant's face temperature is determined.

6. The method according to claim 5, wherein a third temperature value is determined in a third region contained in the first region.

7. The method according to claim 6, wherein at least one of parameters and correcting variables of a temperature control arrangement are determined based on a temperature value determined by the calibrated first temperature detecting device.

8. A temperature determining apparatus, comprising:
a first temperature detecting device which detects a temperature within a first region;
a calibrating device; and
a second temperature detecting device for determining a second temperature value in a second region contained in the first region; wherein,
the calibrating device calibrates the first temperature detecting device based on the second temperature value.

9. The temperature determining apparatus according to claim 8, wherein the first temperature detecting device comprises a thermal imaging camera.

10. The temperature determine apparatus according to claim 9, wherein the thermal imaging camera comprise an infrared camera.

11. The temperature determining apparatus according to claim 9, wherein the thermal imaging camera comprises an array of one of microstructured bolometers, thermoelements and pyroelectric elements.

12. The temperature determining apparatus according to claim 11, wherein the second temperature detecting device comprises a sensor having a high temperature accuracy.

13. The temperature determining apparatus according to claim 12, wherein the sensor comprises an infrared sensor.

14. The temperature determining apparatus according to claim 12, wherein the second temperature detecting device is arranged with a housing of the first temperature detecting device.

15. The temperature determining apparatus according to claim 12, wherein:
each of the first and second temperature detecting devices has its own housing; and
the temperature detecting devices are mutually adjusted.

16. The temperature determining apparatus according to claim 15, wherein the housings are mutually connected.

17. The temperature determining apparatus according to claim 12, wherein the first and the second temperature detecting devices are jointly integrated on a chip.

18. The temperature determining apparatus according to claim 17, wherein the calibrating device comprises an electronic circuit to which the signals of the first and the second temperature detecting devices are fed.

19. The temperature determining apparatus according to claim 18, wherein a third temperature detecting device is provided for detecting a third temperature in a third region, which is also contained in the first region.

20. An air-conditioning system having a temperature determining arrangement, comprising:
a first temperature detecting device which detects a temperature within a first region;
a calibrating device; and
a second temperature detecting device for determining a second temperature value in a second region contained in the first region; wherein,
the calibrating device calibrates the first temperature detecting device based on the second temperature value.
